(19) United States
(12) Patent Application Publication
(10) Pub. No.: US 2025/0244252 A1
(43) Pub. Date: Jul. 31, 2025

(54) INSPECTION DEVICE AND INSPECTION METHOD

(71) Applicant: CHENG MEI INSTRUMENT TECHNOLOGY CO., LTD., HSINCHU COUNTY (TW)

(72) Inventors: CHIH-YUAN LIN, HSINCHU COUNTY (TW); CHIN-YU LIU, HSINCHU COUNTY (TW); YU-WEI LIU, HSINCHU COUNTY (TW); HUNG-CHUN LO, HSINCHU COUNTY (TW); CHAO-YU HUANG, HSINCHU COUNTY (TW); CHUN-PIN HSU, HSINCHU COUNTY (TW); CHENG-TAO TSAI, HSINCHU COUNTY (TW)

(21) Appl. No.: 18/807,410

(22) Filed: Aug. 16, 2024

(30) Foreign Application Priority Data
Jan. 29, 2024 (TW) 113103403

(51) Int. Cl. G01N 21/88

(52) U.S. Cl. CPC G01N 21/8806; G01N 2021/8825; G01N 2021/8845; G01N 2021/8848

(57) ABSTRACT

The present disclosure discloses an inspection device and an inspection method. The inspection device includes a first light source, a second light source, a light source controller and a sensor. The light source controller is configured to enable the first light source to irradiate an object under inspection in a first period of an inspection phase, and to enable the second light source to irradiate the object under inspection in a second period of the inspection phase. The sensor continuously senses the reflected light of the object under inspection in an exposure period of the inspection phase so as to obtain image data of the object under inspection. The exposure period includes the first period and the second period.

### CROSS-REFERENCE TO RELATED APPLICATIONS

This application claims priority of Taiwan application No. 113103403, filed on Jan. 29, 2024, which is incorporated by reference in its entirety.

### BACKGROUND OF THE PRESENT DISCLOSURE

### Field of the Present Disclosure

The present disclosure discloses an inspection device, and more particularly to an inspection device suitable for automated optical inspection (AOI).

### Description of the Prior Art

Automated optical inspection (AOI) performs object surface inspection by using machine vision, and features high-speed and high-precision characteristics. However, for some materials with slight surface relief or high roughness, certain inspection difficulties still exist and not all requirements can be met. In the prior art, a differential interference contrast (DIC) technique can be used to emphasize contour contrast of slight relief of a surface, and a dome light can be used to reduce surface contrast of a rough surface to obtain an image with a smooth surface, and then an algorithm is used for recognition so as to determine abnormalities and defects therein. However, both of the inspection methods above significantly increase requirements for brightness of light sources needed for the AOI, thereby causing higher hardware costs and greater power consumption. In such case, there is a need for a solution as an alternative effective inspection method in the related field.

### SUMMARY OF THE PRESENT DISCLOSURE

One aspect of the present disclosure provides an inspection device. The inspection device includes a first light source, a second light source, a light source controller, and a sensor. The light source controller is configured to enable the first light source to irradiate an object under inspection in a first period of the inspection phase, and to enable the second light source to irradiate the object under inspection in a second period of the inspection phase. The sensor is configured to continuously sense a reflected light of the object under inspection in an exposure period of the inspection phase so as to obtain image data of the object under inspection, wherein the exposure period comprises at least a part of the first period and at least a part of the second period.

Another aspect of the present disclosure provides an inspection method. The method includes, in an inspection phase, enabling a first light source to irradiate an object under inspection in a first period, enabling a second light source to irradiate the object under inspection in a second period, and continuously sensing a reflected light of the object under inspection in an exposure period so as to obtain image data of the object under inspection. The exposure period comprises at least a part of the first period and at least a part of the second period.

### BRIEF DESCRIPTION OF THE DRAWINGS

FIG. 1 is a schematic diagram of an inspection device according to one embodiment of the present disclosure.

FIG. 2 is a schematic diagram of image data obtained when an object under inspection is still.

FIG. 3 is a schematic diagram of image data obtained when an object under inspection is moving.

FIG. 4 is a timing diagram of operations in an inspection phase of an inspection device.

FIG. 5 is a schematic diagram of the movement platform in FIG. 1 moving an object under inspection.

FIG. 6 is a schematic diagram of an inspection device according to another embodiment of the present disclosure.

FIG. 7 is a schematic diagram of an inspection device according to another embodiment of the present disclosure.

FIG. 8 is a timing diagram of operations in an inspection phase of the inspection device in FIG. 7.

FIG. 9 is a schematic diagram of an inspection device according to another embodiment of the present disclosure.

FIG. 10 is a flowchart of an inspection method according to one embodiment of the present disclosure.

### DETAILED DESCRIPTION OF THE EMBODIMENTS

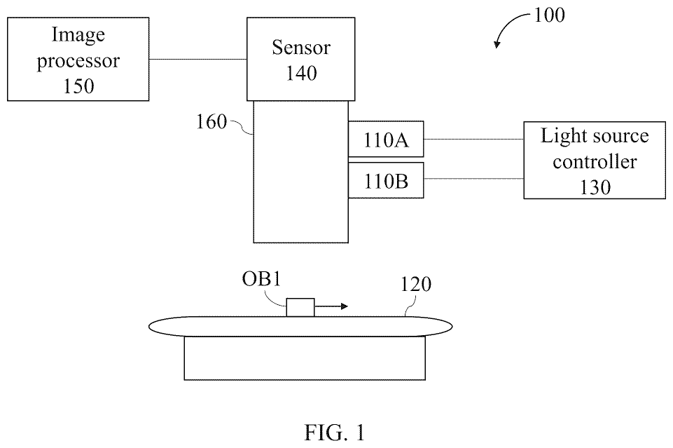

FIG. 1 shows a schematic diagram of an inspection device 100 according to one embodiment of the present disclosure. The inspection device 100 can include a light source 110A, a light source 110B, a light source controller 130 and a sensor 140. In some embodiments, the light source controller 130 can respectively enable the light sources 110A and 110B in a first period and a second period of an inspection phase so as to irradiate an object OB1 under inspection, and the sensor 140 can continuously sense the reflected light of the object OB1 under inspection during a moving process of the object OB1 so as to obtain image data of the object OB1. In some embodiments, the light sources 110A and 100B can emit lights corresponding to different wavebands, different intensities and/or different polarization states. In such case, the object OB1 can receive illumination from different light sources in different periods so as to present different characteristics, and the sensor 140 can continuously sense images of different feature points, thereby enriching the contents of the image data of the object OB1 under inspection and facilitating the defect inspection on the object OB. Moreover, in the present embodiment, both of the light sources 110A and 110B are bright-field light sources; however, the present disclosure is not limited thereto. In some other embodiments, the light sources 110A and 110B can each be a bright-field light source, a dark-field light source and/or a backlight light source.

Moreover, in some embodiments, the inspection device 100 can further include a movement platform 120. The movement platform 120 can carry the object OB1 under inspection, and can move the object OB1 during the inspection phase. The sensor 140 can sense reflected lights from different feature points during the moving process of the object OB1, so more three-dimensional image data can be obtained by superposing the different feature points, thereby facilitating the defect inspection on the object OB1. In some embodiments, the inspection device 100 can further include an image processor 150, which can perform defect inspection on the object OB1 according to the image data obtained by the sensor 140.

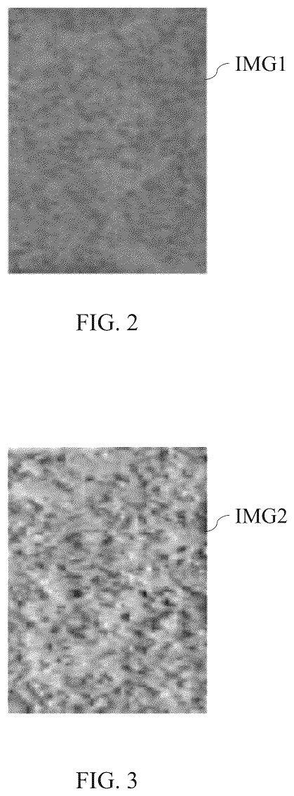

FIG. 2 shows a schematic diagram of image data IMG1 obtained when the object OB1 is still. FIG. 3 shows a schematic diagram of image data IMG2 obtained when the object OB1 is moving. It can be observed from FIG. 2 and FIG. 3 that, surface relief of the object OB1 can be presented more clearly in the image data obtained during the moving process of the object OB1, such that the image processor 150 is able to perform inspection more accurately.

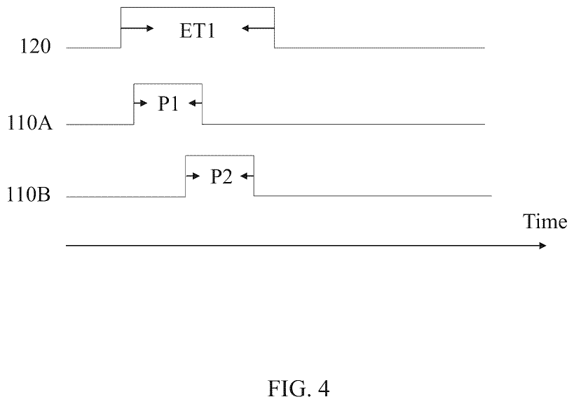

FIG. 4 shows a timing diagram of operations in an inspection phase of the inspection device 100 of the present disclosure. As shown in FIG. 4, in the inspection phase, the light source controller 130 can enable the light source 110A to irradiate the object OB1 in a first period P1, and can enable the light source 110B to irradiate the object OB1 in a second period P2. Moreover, the sensor 140 can continuously sense the reflected light of the object OB1 that is moving during an exposure period ET1 of the inspection phase so as to obtain the image data of the object OB1. In some embodiments, the exposure period ET1 can include the first period P1 and the second period P2; however, the present disclosure is not limited to the example above. In some embodiments, the exposure period ET1 can include only a part of the first period P1 and a part of the second period P2.

In some embodiments, the first light source 110A and the second light source 110B can be configured to provide lights of different wavebands. Since lights of different wavebands can have different penetrating abilities and different refractive indices for the object OB1, defects can be detected with higher possibility by illuminating the object OB1 with lights of different wavebands. For example, the first light 110A can emit visible light, and the second light source 110B can emit invisible light, for example, ultraviolet light or infrared light. Moreover, in some embodiments, the first light source 110A and the second light source 110B can also be configured to emit lights of different intensities and/or emit lights of different polarization states. For example, the first light source 110A can emit a light having a polarization direction parallel to an incident plane (e.g., having a P polarization state), and the second light source 110B can emit a light having a polarization direction perpendicular to an incident plane (e.g., having an S polarization state). Since lights in different polarization states can have different penetrating abilities and refraction angles with respect to different materials (for example, crystals and non-crystals), it is also possible to present different features on the object OB1 by irradiating the object OB1 with lights having different polarization states, thereby increasing the possibility to detect defects of the object OB1.

In some embodiments, as shown in FIG. 4, the first period P1 and the second period P2 can be partially overlapping, so that the object OB1 under inspection can be simultaneously irradiated by the lights emitted by the first light source 110A and the second light source 110B. In some embodiments, the first period P1 and the second period P2 can be substantially completely overlapping. However, in some embodiments, the first period P1 and the second period P2 can be partially non-overlapping, so that the sensor 140 can sense both the image data when the object OB1 is irradiated by only the first light source 110A and the image data when the object OB1 is irradiated only by the second light source 110B. In some embodiments, the first period P1 and the second period P2 can be completely overlapping, partially overlapping, or completely non-overlapping.

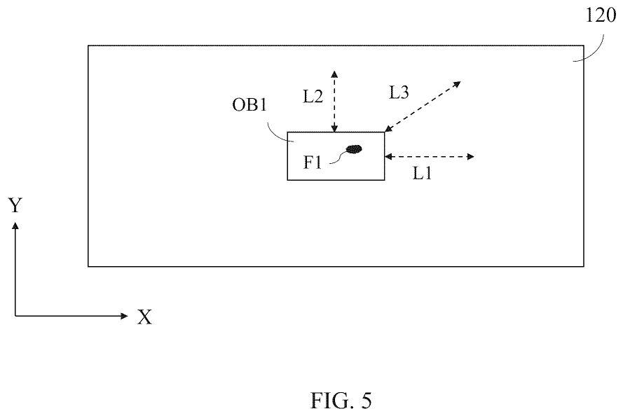

FIG. 5 shows a schematic diagram of the movement platform 120 of the present disclosure moving the object OB1 under inspection. In some embodiments, the movement platform 120 can include rollers and a track, and the object OB1 under inspection can be carried on the track. In such case, the movement platform 120 can drive the track by rotating the rollers to move the object OB1 thereon along straight lines. However, the present application does not limit the movement platform 120 to include the rollers and the track. In some other embodiments, the movement platform 120 can also include other moving members to move the object OB1 under inspection.

In FIG. 3, the movement platform 120 can move the object OB1 under inspection, for example, along a straight line L1 in the X direction. When the object OB1 moves toward the right (e.g., toward the side which an X-axis component increases) along the straight line L1, obvious changes of light and shadow may be presented on a right boundary of a defect F1 of the object OB1, allowing the image processor 150 to detect the right boundary of the defect F1 and thereby detect an abnormality. Similarly, when the object OB1 under inspection moves toward the left (e.g., toward the side which an X-axis component decreases along the straight line L1), obvious changes of light and shadow may be presented on a left boundary of the defect F1 of the object OB1, allowing the image processor 150 to detect the left boundary of the defect F1 and thereby detect an abnormality. In some embodiments, the movement platform 120 allows the object OB1 under inspection to move back and forth on the straight line L1. Thus, the left boundary and the right boundary of the defect F1 can be emphasized during the moving process, allowing the image processor 150 to more accurately detect the defect F1.

Moreover, in some embodiments, the movement platform 120 can also move the object OB1 under inspection along a straight line L2 in the Y direction, so as to emphasize a boundary on an upper side (e.g., the side which a Y-axis component increases) and/or a lower side (e.g., the side which a Y-axis component decreases) of the defect F1 of the object OB1 under inspection. Alternatively, in some embodiments, the movement platform 120 can also move the object OB1 along a straight line L3 between the X direction and the Y direction, so as to emphasize a boundary on an upper-right side and/or a lower-left side of the defect F1 of the object OB1 under inspection.

Although the inspection device 100 in the embodiment in FIG. 1 can move the object OB1 under inspection by the movement platform 120 during the exposure period of the sensor 140, the present disclosure is not limited thereto. In some other embodiments, the movement platform 120 can also keep the object OB1 still during the exposure period. In such case, the movement platform 120 can be replaced by a still platform having merely a carrying function without being able to move an object under inspection.

In the embodiment in FIG. 1, the inspection device 100 can further include a lens module 160, which can include at least one lens. The lens module 160 is able to focus lights so that the sensor 140 can sense the reflected light of the object OB1 more readily. In some embodiments, if a pixel size of the sensor 140 is A and a magnification of the lens module 160 is B, a pixel resolution C can be represented as A/B. In such case, if a velocity at which the movement platform 120 moves the object OB1 is V and a length of the exposure period ET1 of the sensor 140 is T, in some embodiments, in order to prevent an overly large movement range of the object OB1 from causing a blurry image during a sensing process of the sensor 140, a relationship among V, T and C can be further defined. For example, in some embodiments, the inspection device 100 can be set such that V·T≤K·C, wherein K is a predetermined value, for example but not limited to, 2, 3.5, 4 or 5. As such, a movement distance of the object OB1 under inspection during the exposure period ET1 can be prevented from getting too long, and thereby preventing the sensed image from being too blurry for detection.

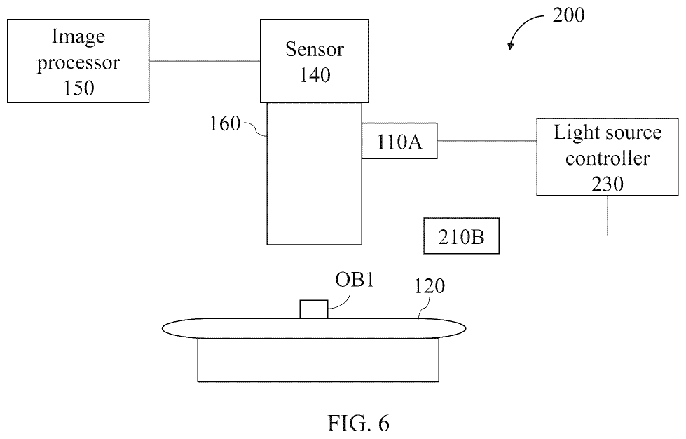

Moreover, in the embodiment shown in FIG. 1, both of the light sources 110A and 110B can be bright-field light sources; however, the present disclosure is not limited to the example above. FIG. 6 shows a schematic diagram of an inspection device 200 according to another embodiment of the present disclosure. The inspection device 200 has a structure similar to that of the inspection device 100. However, the inspection device 200 can include the light source 110A and a light source 210B, wherein the light source 110A can be a bright-field light source and the light source 210B can be a dark-field light source. In some embodiments, a light source controller 230 can control the light sources 110A and 210B according to a control timing shown in FIG. 4. For example, the light source controller 230 can respectively enable the light sources 110A and 210B to irradiate the object OB1 under detection in the first period P1 and in the second period P2 (as shown in FIG. 4).

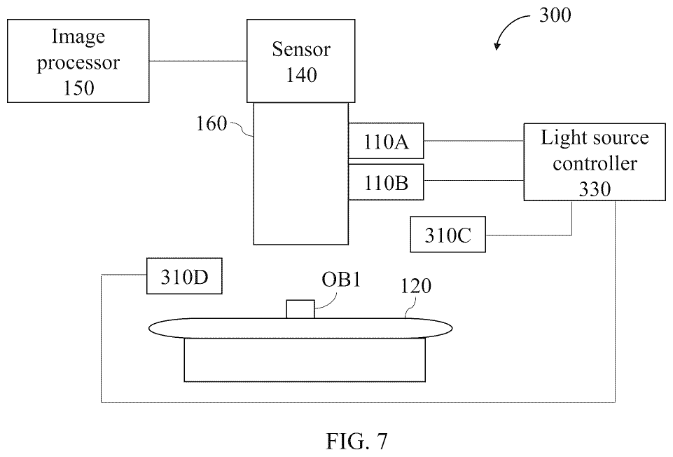

In some embodiments, the inspection devices 100 or 200 can include more bright-field light sources, dark-field sources and/or backlight light sources. FIG. 7 shows a schematic diagram of an inspection device 300 according to another embodiment of the present disclosure. The inspection device 300 has a structure similar to that of the inspection device 100. However, the inspection device 300 can further include a light source 310C and a light source 310D, wherein the light sources 110A and 110B can be bright-field light sources, and the light sources 310C and 310D can be dark-field light sources. In some embodiments, the light sources 110A and 100B can emit lights of different wavebands, different intensities and/or different polarization states. Moreover, the light sources 310C and 310D can emit lights of different wavebands, different intensities, different polarization states and/or different angles.

In some embodiments, in the detection phase, the light source 110A, the light source 110B, the light source 310C and the light source 310D can simultaneously irradiate the object OB1 under inspection in some periods, or different light sources can be combined to irradiate the object OB1 in different periods according to requirements, so as to increase the chances for the image processor 150 to detect a defect. In some embodiments, the light source 110A, the light source 110B, the light source 310C and the light source 310D can be any combination of bright-field light sources, dark-field sources and backlight light sources, and can correspond to different wavebands, different intensities, different polarization states and/or different incident angles.

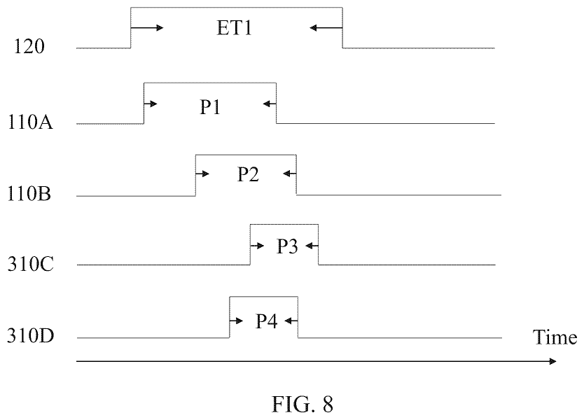

FIG. 8 shows a timing diagram of operations in an inspection phase of the inspection device 300 of the present disclosure. As shown in FIG. 8, in the inspection phase, a light source controller 330 can enable the light source 110A to irradiate the object OB1 under inspection in a first period P1, enable the light source 110B to irradiate the object OB1 in a second period P2, enable the light source 310C to irradiate the object OB1 in a third period P3, and enable the light source 310D to irradiate the object OB1 in a fourth period P4. Moreover, a sensor 140 can continuously sense the reflected light of the object OB1 in an exposure period ET1 of the inspection phase so as to obtain the image data of the object OB1 under inspection. In some embodiments, the exposure period ET1 can include the first period P1, the second period P2, the third period P3 and the fourth period P4. In some embodiments, the first period P1, the second period P2, the third period P3 and the fourth period P4 can be partially overlapping and partially non-overlapping. In some embodiments, during the exposure period ET1 of the sensor 140, the movement platform 120 can further move the object OB1 under inspection, so that the sensor 140 can superimpose images of different feature points, thereby facilitating the defect inspection.

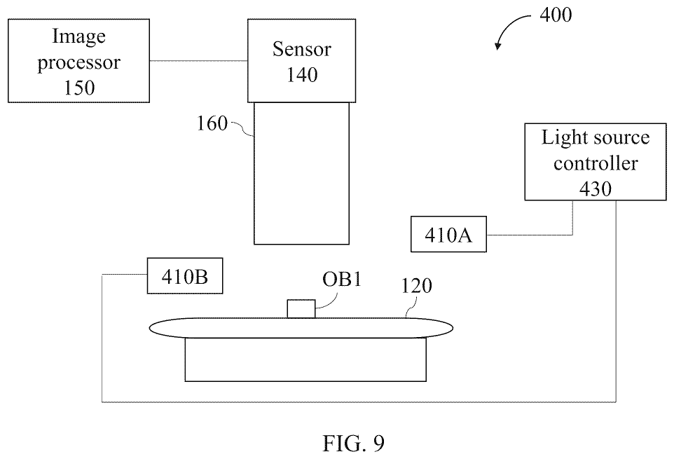

FIG. 9 shows a schematic diagram of an inspection device 400 according to another embodiment of the present disclosure. The inspection device 400 has a structure similar to that of the inspection device 100. However, the inspection device 400 can include a light source 410A and a light source 410B, wherein both of the light source 410A and the light source 410B can be dark-field light sources. Moreover, the light sources 410A and 410B can emit dark-field lights of different wavebands, different intensities, different polarization states and/or different angles. Moreover, in some embodiments, a light source controller 430 can control the light sources 410A and 410B according to the control timing shown in FIG. 4. For example, the light source controller 430 can enable the light source 410A to irradiate the object OB1 in the first period P1, and can enable the second light source 410B to irradiate the object OB1 in the second period P2.

Since the sensor 140 of the inspection device 400 can continuously sense the reflected light of the object OB1 during a moving process of the object OB1 in the inspection phase, more three-dimensional image data can be provided so as to better perform the defect inspection on the object OB1. In some embodiments, the movement platform 120 can also keep the object OB1 still during the exposure period of the sensor 140. In such case, the sensor 140 is still able to sense different features of the object OB1 presented under different light sources, thereby facilitating the defect inspection on the object OB1.

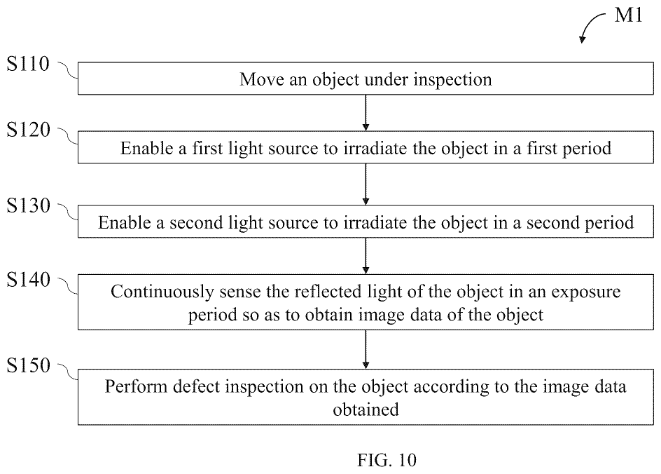

FIG. 10 is a flowchart of an inspection method M1 according to one embodiment of the present disclosure. As shown in FIG. 10, the inspection method M1 includes steps S110 to S150, and can be performed by the inspection device 100, 200, 300 or 400.

For example, in step S110, the inspection device 100 can move the object OB1 under inspection by the movement platform 120. In steps S120 and S130, the light source controller 130 can respectively enable the light sources 110A and 110B to irradiate the object OB1 in the first period P1 and the second period P2 (as shown in FIG. 4). Moreover, in step S140, the sensor 140 can continuously detect the reflected light of the object OB1 that is moving during the exposure period ET1 so as to obtain image data of the object OB1. In step S150, the image processor 150 can perform defect inspection on the object OB1 under inspection according to the image data obtained by the sensor S140.

The sensor 140 can sense reflected lights from different feature points during a moving process of the object OB1 under inspection, and so more three-dimensional image data can be obtained by superimposing the different feature points, allowing the image processor 150 to better perform defect inspection on the object OB1. However, in some other embodiments, step S110 in the method M1 can also be omitted according to inspection operation requirements, that is, the object OB1 under inspection is kept substantially still during the exposure process of the sensor 140.

In some embodiments, the light sources 110A and 110B can emit lights of different wavebands, different intensities and/or different polarization states. Moreover, in some embodiments, the first period P1 and the second period P2 can be partially overlapping, such that the object OB1 under inspection can be simultaneously irradiated by the lights emitted by the two light sources 110A and 110B. As such, the sensor 140 can simultaneously sense more enriched image data, thereby increasing the chances for the image processor 150 to detect a defect.

In some embodiments, when the method M1 is applied to the inspection device 300, the method M1 can further include enabling the light source 310C and the light source 310D in a corresponding period (for example, the periods P3 and P4 in FIG. 8). In some other embodiments, the method M1 and the inspection devices 100, 200, 300 and 400 can also use more light sources, so as to increase the image information that can be obtained by the sensor 140, thereby enhancing defect inspection accuracy.

In summary, the inspection device and the inspection method provided by the embodiments of the present disclosure can use different types of light sources, for example but not limited to, bright-field light sources, dark-field light sources and backlight light sources, and the individual light sources can provide lights of different wavebands, different intensities, different polarization states and/or different angles. As such, a user can use combinations of different light sources (including using only one single light source) in multiple periods according to requirements, so that an object under inspection can present different features so as to better perform defect inspection on the object under inspection.

Moreover, the inspection device and the inspection method provided by the embodiments of the present disclosure are able to move the object under inspection and sense the reflected light of the object during a moving process of the object. The sensor can sense reflected lights from different feature points during the moving process of the object, so that more three-dimensional image data can be obtained by superimposing the different feature points, thereby facilitating the defect inspection on the object.

Disclosure and advantages of the present application have been described in detail above. However, it should be noted that, without departing from the spirit and scope of the disclosure of the present application accorded with the appended claims, various modifications, replacements, substitutions and changes can be made. For example, various processes described above can be implemented by different methods and be replaced by other process or by combinations thereof.

Moreover, the scope of the present application is not limited to specific implementation forms of the processes, machines, manufactured products, substance compositions, means, methods and steps described in the detailed description. On the basis of the present application from the disclosure above, a person of ordinary skill in the technical field would have been able to understand and practice the processes, machines, manufactured products, substance compositions, means, methods and steps that are currently available or to be developed, or perform substantially the same functions or achieve substantially the functions. Therefore, such processes, machines, manufactured products, substance compositions, means, methods and steps are also to be encompassed with the scope of protection of the appended claims.

What is claimed is:

1. An inspection device, comprising:
a first light source;
a second light source;
a light source controller, configured to enable the first light source to irradiate an object under inspection in a first period of an inspection phase, and to enable the second light source to irradiate the object under inspection in a second period of the inspection phase; and
a sensor, configured to continuously sense a reflected light of the object under inspection in an exposure period of the inspection phase so as to obtain image data of the object under inspection, wherein the exposure period comprises at least a part of the first period and at least a part of the second period.

2. The inspection device according to claim 1, further comprising a movement platform configured to carry the object under inspection and move the object under inspection during the exposure period of the sensor.

3. The inspection device according to claim 2, wherein the movement platform moves the object under inspection along a straight line.

4. The inspection device according to claim 1, wherein the first period is partially overlapping with the second period.

5. The inspection device according to claim 1, wherein a light emitted by the first light source in the first period and a light emitted by the second light source in the second period correspond to different wavebands.

6. The inspection device according to claim 1, wherein a light intensity emitted by the first light source in the first period is different from a light intensity emitted by the second light source in the second period.

7. The inspection device according to claim 1, wherein a light emitted by the first light source in the first period and a light emitted by the second light source in the second period have different polarization states.

8. The inspection device according to claim 1, wherein the first light source is a bright-field light source, a dark-field light source or a backlight light source, and the second light source is a bright-field light source, a dark-field light source or a backlight light source.

9. The inspection device according to claim 1, wherein the first light source and the second light source are bright-field light sources, and the inspection device further comprises at least one dark-field light source, wherein the light source controller is further configured to enable the at least one dark-field light source to irradiate the object under inspection in at least one third period of the inspection phase, and the exposure period of the sensor in the inspection phase further comprises the at least one third period.

10. The inspection device according to claim 1, wherein the first light source and the second light source are dark-field light sources irradiating the object under inspection at different angles.

11. An inspection method, comprising, in an inspection phase:
enabling a first light source to irradiate an object under inspection in a first period;
enabling a second light source to irradiate the object under inspection in a second period; and
continuously sensing a reflected light of the object under inspection in an exposure period so as to obtain image data of the object under inspection;
wherein the exposure period comprises at least a part of the first period and at least a part of the second period.

12. The method according to claim 11, further comprising moving the object under inspection in the exposure period.

13. The method according to claim 12, wherein the step of moving the object under inspection in the exposure period comprises moving the object under inspection along a straight line.

14. The method according to claim 11, wherein the first period is partially overlapping with the second period.

15. The method according to claim 11, wherein a light emitted by the first light source in the first period and a light emitted by the second light source in the second period correspond to different wavebands.

16. The method according to claim 11, wherein a light intensity emitted by the first light source in the first period is different from a light intensity emitted by the second light source in the second period.

17. The method according to claim 11, wherein a light emitted by the first light source in the first period and a light emitted by the second light source in the second period have different polarization states.

18. The method according to claim 11, wherein the first light source is a bright-field light source, a dark-field light source or a backlight light source, and the second light source is a bright-field light source, a dark-field light source or a backlight light source.

19. The method according to claim 11, wherein both of the first light source and the second light source are bright-field light sources, and the method further comprises enabling at least one dark-field light source to irradiate the object under inspection in at least one third period of the inspection phase, wherein the exposure period further comprises the at least one third period.

20. The method according to claim 11, wherein the first light source and the second light source are dark-field light sources irradiating the object under inspection at different angles.
